(19) United States
(12) Patent Application Publication
(10) Pub. No.: US 2022/0210291 A1
(43) Pub. Date: Jun. 30, 2022

(54) PROCESSING OF IMAGE FORMING JOB BASED ON METADATA TAG INPUT

(71) Applicant: HEWLETT-PACKARD DEVELOPMENT COMPANY, L.P., Spring, TX (US)

(72) Inventor: Changnam AN, Seongnam-si (KR)

(73) Assignee: HEWLETT-PACKARD DEVELOPMENT COMPANY, L.P., Spring, TX (US)

(21) Appl. No.: 17/606,671

(22) PCT Filed: May 21, 2020
(86) PCT No.: PCT/US2020/033974

§ 371 Date: Oct. 26, 2021

(30) Foreign Application Priority Data
Nov. 26, 2019 (KR) 10-2019-0153563

(51) Int. Cl. H04N 1/32; G06F 40/40; G06F 3/12

(52) U.S. Cl. CPC H04N 1/32133; G06F 40/40; G06F 3/1288; H04N 2201/3242; G06F 3/1204; H04N 2201/3212; G06F 3/1253

(57) ABSTRACT

An example cloud server includes a communication interface apparatus, a processor, and a memory storing instructions executable by the processor. The processor may receive a request for an image forming job including a metadata tag through the communication interface apparatus by executing the instructions, may convert the metadata tag included in the received request for the image forming job into option information used for the image forming job, and may process the image forming job based on the option information.

### BACKGROUND

In order to perform a print job, a user may select an image forming apparatus among a plurality of image forming apparatuses connected to a network and search and select various print option information for the print job on a user interface screen. In order to scan a document and stored the scanned image in an external storage, the user may select and set various option information for scanning and storing in the external storage on the user interface screen. Accordingly, the user should be familiar with a location, a meaning, and a usage of a relevant setting menu on the user interface screen in order to perform an image forming job.

### BRIEF DESCRIPTION OF THE DRAWINGS

Various examples will be described below by referring to the following figures.

FIG. 1 is a diagram for describing a cloud printing service environment according to an example.

FIG. 2 is a diagram for describing a configuration and an operation of a cloud server according to an example.

FIG. 3 is a diagram for describing a process of converting a metadata tag into option information used for an image forming job according to an example.

FIG. 4 is a diagram for describing a method of providing a cloud printing service according to an example.

FIG. 5 is a diagram for describing a cloud printing service environment in which a cloud server receives a request for a print job including a metadata tag and processes the request according to an example.

FIG. 6 is a diagram for describing operations of an image forming apparatus, a user terminal, a cloud server, and a natural language processing system according to an example.

FIG. 7 is a diagram for describing a cloud printing service environment in which a cloud server receives a request for a job of storing a scanned document including a metadata tag in an external storage and processes the request according to an example.

FIG. 8 is a diagram for describing operations performed by an image forming apparatus, a cloud server, a natural language processing system, an authentication system, and an external storage according to an example.

### DETAILED DESCRIPTION OF EXAMPLES

Hereinafter, various examples are described referring to the drawings. In the present specification and drawings, components having substantially the same functional configuration are labeled with the same reference numerals to omit repeated description.

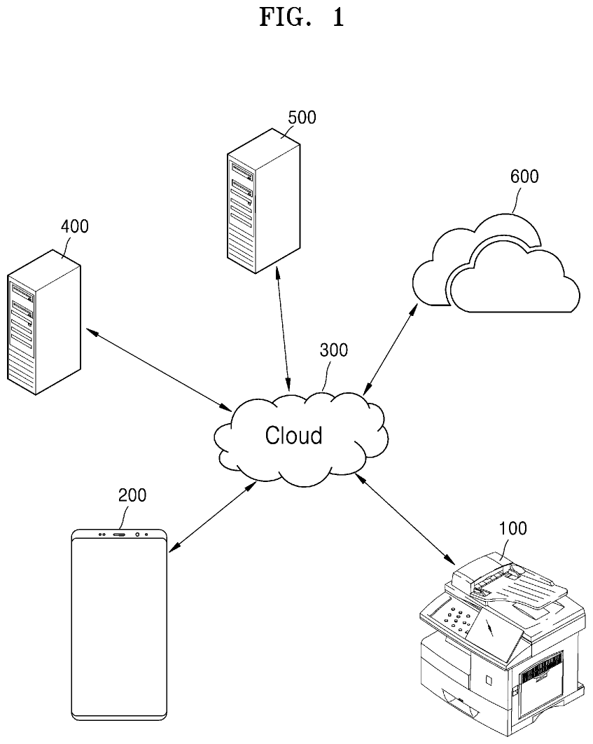

FIG. 1 is a diagram for describing a cloud printing service environment according to an example.

Referring to FIG. 1, an image forming apparatus 100 is a collective term for an apparatus capable of performing an image forming job, such as a printer, a copier, a scanner, a multi-function printer, a fax machine, or the like. An image forming job may refer to any of various jobs related to an image, for example, printing, copying, scanning, or faxing, and may include a series of processes required to perform an image forming job.

A user terminal 200 may be a computing apparatus such as a smartphone, a laptop, etc.

A cloud server 300 may provide a cloud printing service and may provide a response to a request made by the image forming apparatus 100 or the user terminal 200. For example, when there is a request for an image forming job from the image forming apparatus 100 or the user terminal 200, the cloud server 300 may perform a process related to the requested image forming job or may process the requested image forming job by using an external apparatus or a server.

External servers 400, 500, and 600 (hereinafter, also referred to as a natural language processing system 400, an authentication system 500, and an external storage 600) may each provide a certain service according to a request of the cloud server 300. For example, according to the request of the cloud server 300, the external servers 400, 500, and 600 may respectively provide a result of performing a natural language process, may provide a result of performing an authentication-related process, or may provide a service such as archiving data.

An example illustrated in FIG. 1 includes a cloud printing service environment in which the cloud server 300 may communicate, mainly based on the cloud server 300, with an external apparatus or a server located outside the cloud server 300. However, an example printing service environment is not limited thereto. The image forming apparatus 100, the user terminal 200, the external servers 400, 500, and 600 may communicate with each other without passing through the cloud server 300.

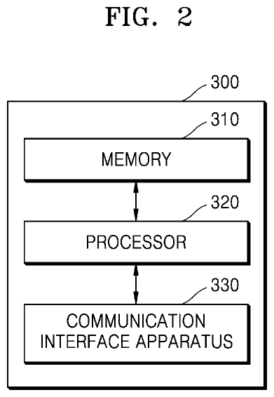

FIG. 2 is a diagram for describing a configuration and an operation of a cloud server according to an example.

Referring to FIG. 2, the cloud server 300 may include a memory 310, a processor 320, and a communication interface apparatus 330. Although not illustrated in FIG. 2, a person skilled in the art understands that other components may be included in addition to the components illustrated in FIG. 2.

The memory 310 may store instructions executable by the processor 320. Various types of data such as a program and a file may be stored in the memory 310. The processor 320 may access and use data stored in the memory 310 or may store new data in the memory 310.

The processor 320 may control an operation of the cloud server 300 and may include at least one processing unit such as a central processing unit (CPU). The processor 320 may execute a program stored in the memory 310, may read data or a file stored in the memory 310, or may store a new file in the memory 310. The processor 320 may perform an operation corresponding to a request received through the communication interface apparatus 330.

The communication interface apparatus 330 may include a communication module (e.g., transceiver) capable of communicating with another device or a network. For example, the communication interface apparatus 330 may include a communication module supporting at least one of various wired or wireless communication methods such as wireless fidelity (Wi-Fi), 3rd generation (3G), 4th generation (4G), 5th generation (5G), and the like. The communication interface apparatus 330 may be connected to an external apparatus or a server located outside the cloud server 300 to transmit and receive signals or data. For example, the communication interface apparatus 330 may transmit a signal or data received from the image forming apparatus 100, the user terminal 200, or the external servers 400, 500, and 600 to the processor 320, or may transmit a signal or data generated from the processor 320 or stored in the memory 310 to the image forming apparatus 100, the user terminal 200, or the external servers 400, 500, and 600.

In an example, the memory 310, the processor 320, and the communication interface apparatus 330 of the cloud server 300 may be connected to each other in order to provide a cloud printing service and may perform the following operations.

The processor 320 may execute an instruction stored in the memory 310, may receive a request for an image forming job including a metadata tag through the communication interface apparatus 330, and may process the requested image forming job. The metadata tag may be input in a hash tag format in a metadata tag file separate from a document on which the image forming job is to be performed, or may be input in a hash tag format in a document on which the image forming job is to be performed. The format of the metadata tag is not limited to a hash tag and may have various formats by combining a specific symbol, a special character, or the like with a word or a phrase.

The processor 320 may convert the metadata tag included in the request for the image forming job received through the communication interface apparatus 330 into option information used for the image forming job. The processor 320 may convert the metadata tag into option information used for the image forming job, through a natural language processing system included in the cloud server 300 or an external natural language processing system performing communication with the cloud server 300.

The processor 320 may process the image processing job, based on the converted option information. For example, the processor 320 may transmit the request for the image forming job including the option information to an external apparatus or a server for performing the image forming job requested to the cloud server 300 or for performing a related process thereto.

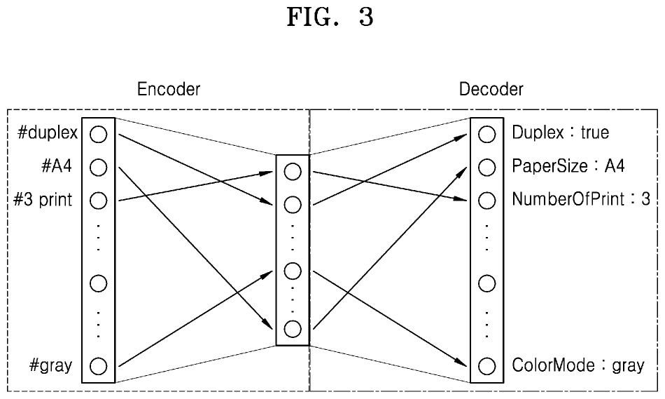

FIG. 3 is a diagram for describing a process of converting a metadata tag into option information used for an image forming job according to an example.

In an example, the metadata tag includes setting option information to be used for the image forming job according to a format that a user may easily input and may intuitively understand. In that case, the user may easily input a metadata tag even when the user is not familiar with the format of the option information used for the image forming job or usage of a user interface for setting the option information.

Since an apparatus for performing an image forming job, such as the image forming apparatus 100, may not recognize and process the metadata tag, the apparatus may convert the unrecognizable metadata tag into option information having a recognizable format to perform the image forming job.

Referring to FIG. 3, the natural language processing system included in the cloud server 300 or the external natural language processing system performing communication with the cloud server 300 may analyze the metadata tag through an encoder, or may convert the metadata tag into the option information having a format that is recognizable by an apparatus performing the image forming job through a decoder.

The encoder may analyze the metadata tag and may convert the metadata tag into intermediate data. The natural language processing system may train various types of option information used for the image forming job and may derive a relevance degree between the metadata tag and the trained option information, thereby converting the metadata tag into the intermediate data. The decoder may convert the intermediate data converted through the encoder into the option information having a format that is recognizable by an apparatus performing the image forming job.

Referring to the examples shown in FIG. 3, “#duplex”, “#A4”, “#3print”, and “#gray”, which are each input in a hash tag format, may each be converted to the intermediate data through the encoder, and may be respectively converted into “Duplex:true”, “PaperSize:A4”, “NumberOfPrint:3”, and “ColorMode:gray”, as the option information having a format that is recognizable by an apparatus performing the image forming job through the decoder.

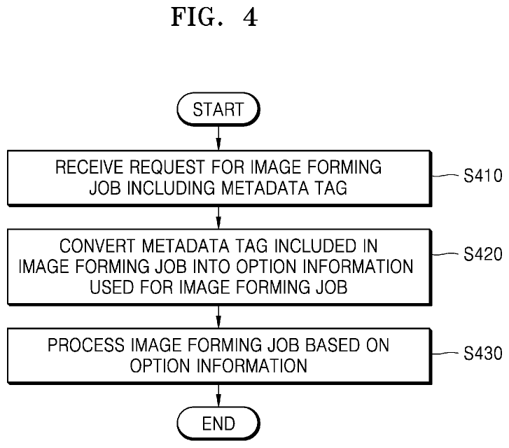

FIG. 4 is a diagram for describing a method of providing a cloud printing service according to an example.

Referring to FIG. 4, the cloud server 300 may receive a request for an image forming job including a metadata tag in operation S410. The metadata tag may be input in a hash tag format to a metadata tag file separate from a document on which the image forming job is to be performed, or may be input in a hash tag format to a document on which the image forming job is to be performed.

In operation S420, the cloud server 300 may convert the metadata tag included in the received request for the image forming job into option information used for the image forming job. The cloud server 300 may convert the metadata tag into the option information used for the image forming job through a natural language processing system included in the cloud server 300 or an external natural language processing system performing communication with the cloud server 300.

In operation S430, the cloud server 300 may process the image forming job, based on the converted option information.

Hereinafter, as an example of requesting an image forming job including a metadata tag to a cloud server, an example method of providing a cloud printing service by a cloud server is described.

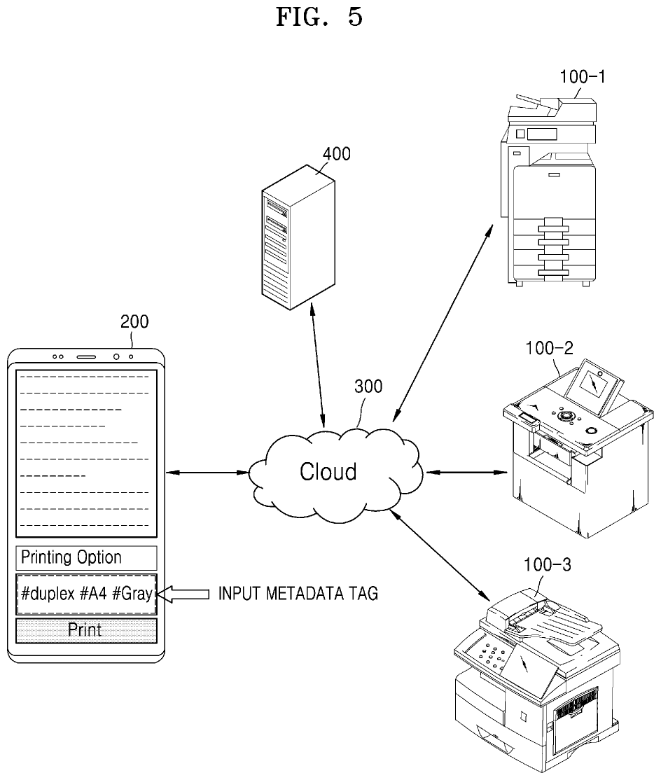

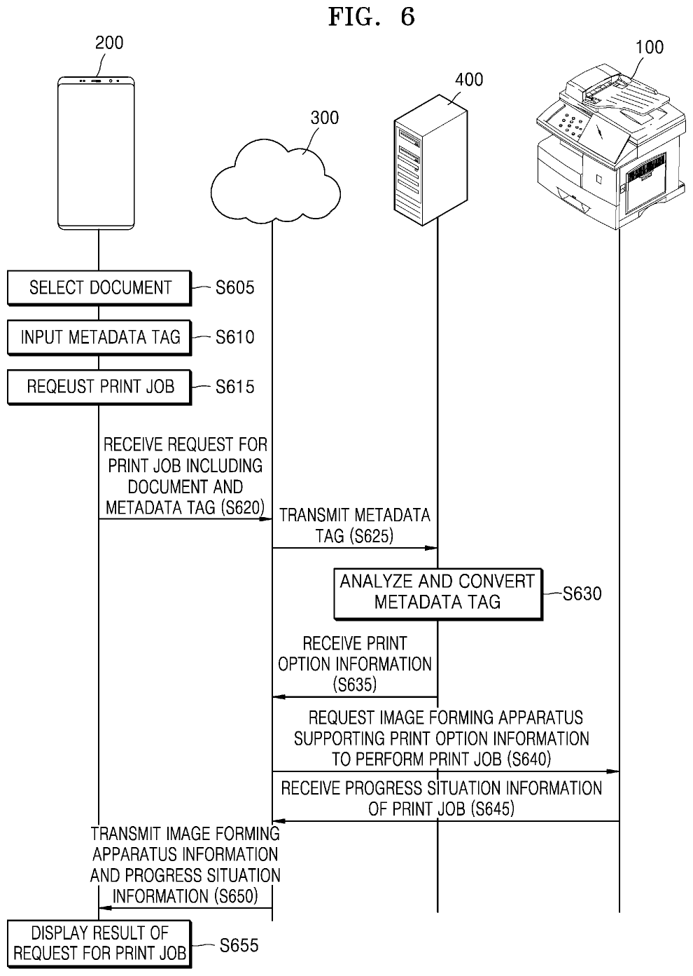

FIGS. 5 and 6 are diagrams of an example in which a cloud server receives a request for a print job including a metadata tag and processes the requested print job.

FIG. 5 is a diagram for describing a cloud printing service environment in which a cloud server receives a request for a print job including a metadata tag and processes the request according to an example.

Referring to FIG. 5, the cloud server 300 is connected to the user terminal 200, a natural language processing system 400, and a plurality of image forming apparatuses 100-1, 100-2, and 100-3. In the following description, the plurality of image forming apparatuses 100-1, 100-2, and 100-3 may collectively be referred to as the image forming apparatus 100.

The user terminal 200 may execute an application according to a user input received through a user interface or may read data or a file stored in a memory or an external space of the user terminal 200. The user terminal 200 may be connected to an external apparatus such as the image forming apparatus 100 or the cloud server 300 according to various wired or wireless communication methods such as Wi-Fi, Wi-Fi Direct, Bluetooth, bluetooth low energy (BLE), near field communication (NFC), 3G, 4G, 5G, and the like.

A user may execute an application in the user terminal 200, may select a document to be printed, and may input a metadata tag to a print option information input box. As shown in FIG. 5, when a user wants to print a document by performing “duplex printing” on an “A4-size sheet” in a “gray color mode”, the user may input “#duplex #A4 #Gray” in a hash tag format to a print option information input box. Subsequently, when the user presses a print button on the user terminal 200, the request for the image forming job including the metadata tag may be transmitted to the cloud server 300. Here, the document to be printed and a metadata tag file to which “#duplex #A4 #Gray” is input may be transmitted to the cloud server 300.

When the cloud server 300 receives the request for the print job including the metadata tag, the cloud server 300 may analyze the metadata tag in order to identify print option information used for the print job. FIG. 5 illustrates an example of converting a metadata tag into option information used for a print job through an external natural language processing system 400 performing communication with the cloud server 300. However, the natural language processing system 400 may be included in the cloud server 300. The cloud server 300 may transmit the received metadata tag file together with the document to be printed to the natural language processing system 400, may analyze the metadata tag which is input in the metadata tag file, and may receive, from the natural language processing system 400, a result of converting the metadata tag into print option information used for the print job.

The cloud server 300 may request an image forming apparatus that supports the print option information, received from the natural language processing system 400, from among the image forming apparatuses 100-1, 100-2, and 100-3, which are connected to a network, to perform the print job. When there are a plurality of pieces of option information to be used for the print job, the cloud server 300 may request an image forming apparatus that supports as many corresponding print options as possible to perform the print job For example, in a case of an example illustrated in FIG. 5, the cloud server 300 may search for an image forming apparatus capable of performing “duplex printing” on an “A4-size sheet” in a “gray color mode” and may request an image forming apparatus that supports all corresponding print options or that supports as many print options as possible to perform a print job.

FIG. 6 is a diagram for describing operations of an image forming apparatus, a user terminal, a cloud server, and a natural language processing system, according to an example.

Referring to FIG. 6, the user terminal 200 may receive a user selection of a document to be printed in operation S605. The document to be printed may include a text, a graphic, or an image.

The user terminal 200 may receive an input including a metadata tag from a user in operation S610. The metadata tag may be input in a hash tag format to a metadata tag file separate from a document on which an image forming job is to be performed.

The user terminal 200 may receive a request for a print job from the user in operation S615. The user terminal 200 may transmit the request for the print job including the document to be printed and the metadata tag to the cloud server 300.

The cloud server 300 may receive the request for the print job including the document to be printed and the metadata tag from the user terminal 200 in operation S620.

The cloud server 300 may transmit the metadata tag to the natural language processing system 400 in operation S625.

The natural language processing system 400 may analyze the metadata tag and may convert, based on an analysis result, the metadata tag into print option information used for the print job in operation S630.

The cloud server 300 may receive the print option information, converted through the natural language processing system 400 and to be used for the print job, from the natural language processing system 400 in operation S635.

The cloud server 300 may request the image forming apparatus 100 that supports the print option information received from the natural language processing system 400 to perform the print job in operation S640. The cloud server 300 may search for the image forming apparatus 100, among image forming apparatuses connected to the cloud server 300, that supports the print option information for processing the print job requested from the user terminal 200.

The cloud server 300 may receive progress situation information of the print job from the image forming apparatus 100 in operation S645.

The cloud server 300 may transmit information of the image forming apparatus 100 requested to perform the print job and the progress situation information of the print job to the user terminal 200 in operation S650.

The user terminal 200 may display a request result of the print job in operation S655. The user terminal 200 may display the information of the image forming apparatus 100 requested to perform the requested print job and a degree of progress or completion of the print job.

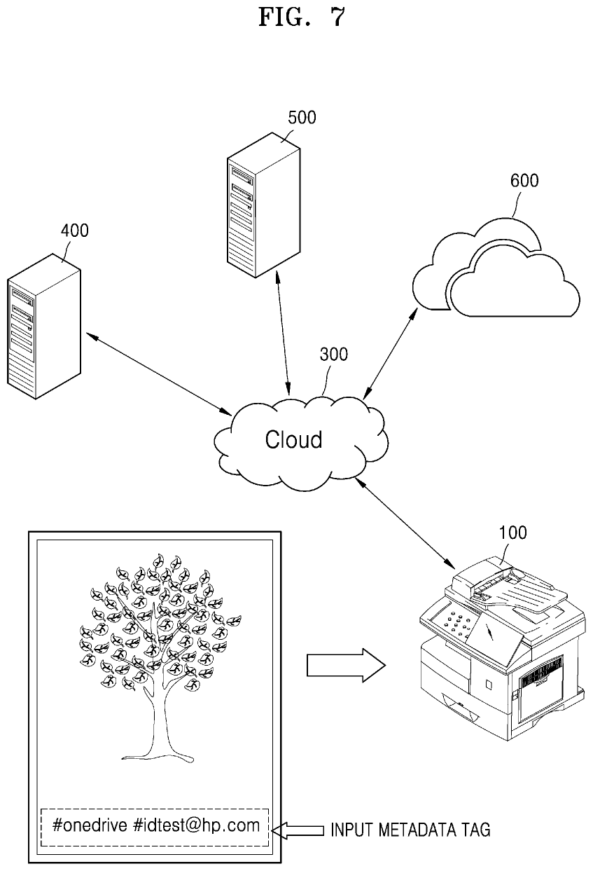

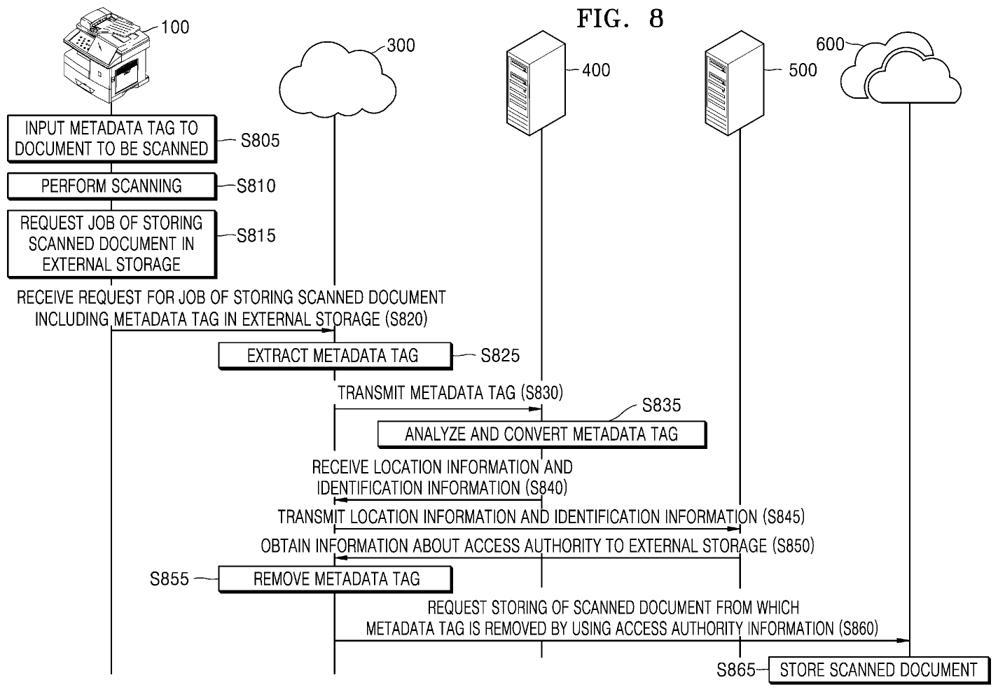

FIGS. 7 and 8 are diagrams in which a cloud server receives a request for a job of storing a scanned document including a metadata tag in an external storage, and processes the requested job according to an example.

FIG. 7 is a diagram for describing a cloud printing service environment in which a cloud server receives a request for a job of storing a scanned document including a metadata tag in an external storage and processes the request according to an example.

Referring to FIG. 7, the cloud server 300 is connected to the image forming apparatus 100, the natural language processing system 400, an authentication system 500, and the external storage 600.

The image forming apparatus 100 may receive a request for an image forming job and may perform an operation corresponding to the requested image forming job. The image forming apparatus 100 may receive the request for the image forming job from a user or an external apparatus. The image forming apparatus 100 may perform wired or wireless communication with another device or a network. The image forming apparatus 100 may include a communication module supporting at least one of various wired or wireless communication methods. The image forming apparatus 100 may be connected to an external apparatus located outside to transmit and receive signals or data. The image forming apparatus 100 may transmit the signals or the data generated from the image forming apparatus 100 to the cloud server 300.

The image forming apparatus 100 may perform an image forming job such as printing, copying, scanning, faxing, a function related thereto, a series of processes required to perform the image forming job, or the like. For example, the image forming apparatus 100 may form an image on a print medium by various printing methods such as an electrophotographic method, an inkjet method, and the like. As another example, the image forming apparatus 100 may irradiate light onto a document, may receive the reflected light, and may read an image recorded on the document for performing scanning.

A user may select a document to be scanned in the image forming apparatus 100 and may input a metadata tag to the document. As shown in FIG. 7, a user may input “#onedrive #idtest@hp.com” in a hash tag format to the document to be scanned. Subsequently, when the user presses a scan start button on the image forming apparatus 100, the image forming apparatus 100 may perform scanning on the document including the metadata tag and may transmit a request for a job of storing the scanned document in the external storage 600 to the cloud server 300. Here, the scanned document to which “#onedrive #idtest@hp.com” is input may be transmitted to the cloud server 300.

When the request for the job of storing the scanned document including the metadata tag in the external storage 600 is received, the cloud server 300 may analyze the metadata tag in order to identify location information and identification information that are used for access to the external storage 600. FIG. 7 illustrates an example of converting the metadata tag into location information and identification information that are used for access to the external storage 600 through the external natural language processing system 400 performing communication with the cloud server 300. However, the natural language processing system 400 may be included in the cloud server 300. The cloud server 300 may extract the metadata tag included in the scanned document and may transmit the extracted metadata tag to the natural language processing system 400, and may analyze the metadata tag and may receive, from the natural language processing system 400, a result of converting the metadata tag into the location information and the identification information that are used for access to the external storage 600.

The cloud server 300 may obtain, from the authentication system 500, information about access authority to the external storage 600 by using the location information and the identification information that are received from the natural language processing system 400 and that are used for access to the external storage 600. The authentication system 500 may be a single sign on (SSO) server. The cloud server 300 may request the external storage 600 to store the scanned document from which the metadata tag is removed by using access authority information obtained from the authentication system 500.

For example, in an example as illustrated in FIG. 7, the cloud server 300 may obtain, from the authentication system 500, the access authority information for access to “onedrive” as the external storage 600 by using “onedrive” as the location information and “idtest@hp.com” as the identification information. The cloud server 300 may remove “#onedrive #idtest@hp.com” from the scanned document and may request the “onedrive” as the external storage 600 to store the scanned document from which “#onedrive #idtest@hp.com” is removed.

In FIG. 7, a job of storing the scanned document in the external storage 600 is described. However, image forming jobs such as SCAN TO SMB, SCAN TO FTP, and SCAN TO E-mail may be processed according to a type of an external apparatus or an external server, which is connected to the cloud server 300.

FIG. 8 is a diagram for describing operations performed by an image forming apparatus, a cloud server, a natural language processing system, an authentication system, and an external storage according to an example.

Referring to FIG. 8, a user may select a document to be scanned in the image forming apparatus 100 and may input a metadata tag to the document to be scanned in operation S805.

The image forming apparatus 100 may perform scanning on the document including the metadata tag in operation S810.

The image forming apparatus 100 may receive, from the user, a request for a job of storing the scanned document in the external storage 600 in operation S815. The image forming apparatus 100 may transmit, to the cloud server 300, the request for the job of storing the scanned document including the metadata tag in the external storage 600.

The cloud server 300 may receive, from the image forming apparatus 100, the request for the job of storing the scanned document including the metadata tag in the external storage 600 in operation S820.

The cloud server 300 may extract the metadata tag included in the scanned document in operation S825.

The cloud server 300 may transmit the extracted metadata tag to the natural language processing system 400 in operation S830.

The natural language processing system 400 may analyze the extracted metadata tag and may convert, based on an analysis result, the extracted metadata tag into location information and identification information for access to the external storage 600 in operation S835.

The cloud server 300 may receive, from the natural language processing system 400, the location information and the identification information for access to the external storage 600, the location information and the identification information being converted through the natural language processing system 400 in operation S840.

The cloud server 300 may transmit the location information and the identification information for access to the external storage 600 to the authentication system 500 in operation S845. The authentication system 500 may identify the location information and the identification information for access to the external storage 600 and may identify information about access authority to the external storage 600.

The cloud server 300 may obtain, from the authentication system 500, the information about access authority to the external storage 600 in operation S850.

The cloud server 300 may remove the metadata tag from the scanned document in operation S855. The cloud server 300 may remove the metadata tag from the scanned document, the metadata tag being input in a hash tag format.

The cloud server 300 may request the external storage 600 to store the scanned document from which the metadata tag is removed by using the access authority information in operation S860.

The external storage 600 may store the scanned document from which the metadata tag is removed in operation S865.

The examples described above may be implemented by a non-transitory computer-readable storage medium storing instructions or data executable by a computer or a processor. The examples may be written as computer programs and may be implemented in general-use digital computers that execute the programs by using a non-transitory computer-readable storage medium. Examples of the non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tape, floppy disks, magneto-optical data storage devices, optical data storage devices, hard disks, solid-state disks (SSDs), and instructions or software, associated data, data files, and data structures, and any device capable of providing instructions or software, associated data, data files, and data structures to a processor or a computer such that the processor or computer may execute instructions.

1. A cloud server comprising:
a communication interface apparatus;
a processor; and
a memory storing instructions executable by the processor,
wherein the processor, by executing the instructions, is to:
receive a request for an image forming job including a metadata tag through the communication interface apparatus,
convert the metadata tag included in the received request for the image forming job into option information used for the image forming job, and
process the image forming job based on the option information.

2. The cloud server of claim 1, wherein the metadata tag includes input in a hash tag format in a metadata tag file separate from a document on which the image forming job is to be performed, or includes input in a hash tag format in a document on which the image forming job is to be performed.

3. The cloud server of claim 1, wherein the processor is to convert the metadata tag into the option information used for the image forming job through a natural language processing system included in the cloud server or an external natural language processing system performing communication with the cloud server.

4. The cloud server of claim 1, wherein, when the image forming job includes a print job, the processor is to:
analyze the metadata tag through a natural language processing system, and
convert, based on an analysis result, the metadata tag into print option information used for the print job.

5. The cloud server of claim 4, wherein the processor is to request an image forming apparatus supporting the print option information to perform the print job through the communication interface apparatus.

6. The cloud server of claim 1, wherein, when the image forming job includes a job of storing a scanned document in an external storage, the processor is to:
extract the metadata tag included in the scanned document,
analyze the extracted metadata tag through a natural language processing system, and
convert, based on the analysis result, the extracted metadata tag into location information and identification information that are used for access to the external storage.

7. The cloud server of claim 6, wherein the processor is to:
obtain, from an authentication system, information about access authority to the external storage by using the location information and the identification information, through the communication interface apparatus, and
request the external storage to store the scanned document from which the metadata tag is removed, by using the obtained access authority information.

8. A method of providing a cloud printing service, the method comprising:
receiving a request for an image forming job including a metadata tag;
converting the metadata tag included in the received request for the image forming job into option information used for the image forming job; and
processing the image forming job based on the option information.

9. The method of claim 8, wherein the metadata tag includes input in a hash tag format in a metadata tag file separate from a document on which the image forming job is to be performed, or includes input in a hash tag format in a document on which the image forming job is to be performed.

10. The method of claim 8, wherein the converting comprises converting the metadata tag into option information used for the image forming job, through a natural language processing system included in a cloud server providing the cloud printing service or an external natural language processing system performing communication with the cloud server.

11. The method of claim 8, wherein, when the image forming job includes a print job, the converting comprises analyzing the metadata tag through a natural language processing system and converting, based on the analysis result, the metadata tag into print option information used for the print job.

12. The method of claim 11, wherein the processing comprises requesting an image forming apparatus supporting the print option information to perform the print job.

13. The method of claim 8, wherein, when the image forming job includes a job of storing a scanned document in an external storage, the converting comprises:
extracting the metadata tag included in the scanned document;
analyzing the extracted metadata tag through a natural language processing system; and
converting, based on the analysis result, the extracted metadata tag into location information and identification information for access to the external storage.

14. The method of claim 13, wherein the processing comprises:
obtaining, from an authentication system, information about access authority to the external storage by using the location information and the identification information; and
requesting the external storage to store scanned data from which the metadata tag is removed, by using the obtained access authority information.

15. A non-transitory computer-readable storage medium storing instructions for providing a cloud printing service, the non-transitory computer-readable storage medium comprising:
instructions to receive a request for an image forming job including a metadata tag;
instructions to convert the metadata tag included in the received request for the image forming job into option information used for the image forming job; and
instructions to process the image forming job based on the option information.

16. A method of providing a cloud printing service, the method comprising:
receiving a selection of a document on which an image forming job is to be performed;
receiving an input of a metadata tag to set option information to be used for the image forming job; and
transmitting a request for the image forming job including the metadata tag to a cloud server to perform the image forming job based on the option information.

17. The method of claim 16, wherein the receiving the input of the metadata tag comprises receiving the input of the metadata tag in a hash tag format in a metadata tag file separate from the document on which the image forming job is to be performed, or receiving the input of the metadata tag in a hash tag format in the document on which the image forming job is to be performed.

18. The method of claim 16, wherein the receiving the selection of the document comprises receiving the selection of the document at a user terminal.

19. The method of claim 18, wherein the receiving the input of the metadata tag comprises receiving the input of the metadata tag at the user terminal.

20. The system of claim 19, wherein the receiving the input of the metadata tag comprises receiving the input of the metadata tag in a hash tag format to a print option information box through a user interface of the user terminal.
